(19) United States
(12) Patent Application Publication
(10) Pub. No.: US 2018/0020613 A1
(43) Pub. Date: Jan. 25, 2018

(54) BELTED CHAIN CONNECTION SYSTEM

(71) Applicants: Rainer Borgmann, Idaho Falls, ID (US); Evan Steel, Shelley, ID (US)

(72) Inventors: Rainer Borgmann, Idaho Falls, ID (US); Evan Steel, Shelley, ID (US)

(73) Assignee: Spudnik Equipment Company LLC, Blackfoot, ID (US)

(21) Appl. No.: 15/216,083

(22) Filed: Jul. 21, 2016

(51) Int. Cl. A01D 17/10; B65G 17/06; B65G 17/38

(52) U.S. Cl. CPC A01D 17/10; B65G 17/38; B65G 17/063; A01D 2017/103

(57) ABSTRACT

A belted chain connection system includes first and second flexible belt portions, each flexible belt portion having first and second ends with integral lugs extending therefrom. A non-circular aperture extends transversely through the integral lugs, and a reinforcing ply is embedded within each flexible belt portion, the reinforcing ply having a continuous portion substantially circumscribing the non-circular aperture in each lug. A non-circular pin is configured to extend transversely through aligned non-circular apertures of the lugs of the first and second ends of adjacent belt segments, to non-rotatably connect the adjacent belt segments.

### BACKGROUND

### Field

The present application relates generally to belted chains, such as are used in agricultural equipment for harvesting root crops and the like. More particularly, the present application relates to a connection system for the flexible belt portion of a belted chain that is simpler, more flexible, and more robust than some prior belt connection systems.

### Related Art

The present application relates to belted chains, such as are used in agricultural equipment for transporting and harvesting crops, including root crops, such as potatoes, sugar beets, onions and the like, and other crops such as tomatoes and cabbage. In the process of harvesting root crops, for example, a harvester is typically drawn along rows of crop. The harvester, which is usually as wide as several crop rows (e.g. 1 to 8 crop rows), typically includes a digging nose at its forward end with one or more belted chains. The digging nose digs into the ground, and the belted chain draws the root crops out of the ground and up into the harvester device.

Belted chains of this type are generally made up of narrow, flexible rubber belts on opposing lateral sides, between which are connected a plurality of transverse metal bars. The flexible belt portions are looped around and interconnected end-to-end to form an endless belt, that is routed around pulleys and drive wheels to allow the belt to transport crops in a desired manner. Gaps between the transverse bars allow dirt and soil to drop from the crops as they are drawn out of the ground and into the harvester.

One challenge associated with belted chains is the manner in which the flexible rubber belt portions are connected together to form the endless loop. Belted chains are typically interconnected with the use of metal clips that provide a hinge-type connection. A metal clip that includes hinge loops at its distal end is mechanically attached (e.g. via rivets or bolts) to the free end of a segment of the flexible belt, and a corresponding metal clip is similarly attached to the free end of the belt segment to be connected. The hinge loops of the corresponding clips are interleaved with each other, and a metal hinge pin is inserted transversely through the interleaved hinge loops, thus providing a pivoting connection between the two metal clips. This provides a relatively strong connection between the two belts.

Unfortunately, belt connections of this type suffer several disadvantages. First, the metal clips themselves are not flexible, and impose significant stress and wear on the flexible belt at their attachment locations when the belt travels around small diameter pulleys and the like. Constant flexure at the connection point tends to shorten the life of the flexible belt, leading to premature failure. Additionally, the metal clips and hinge pins of these belts present metal-on-metal sliding friction, and can wear away relatively quickly. Belted chains generally operate in a relatively harsh environment, with frequent exposure to dirt, sand, grit, moisture, etc. This environment can fairly rapidly wear away the metal hinge loops and hinge pins, thus increasing maintenance expense and down time. When a belt connection is to be repaired, the belt is generally shortened to remove the frayed or worn end, and the metal clip is attached at the location of the next transverse bar. It will be apparent that this sort of repair technique will shorten the length of the belt each time it is performed, and therefore can only be done a limited number of times before the entire belt is too short to use, and must be entirely discarded and replaced with a new belt. This is wasteful. Replacement of the metal clips in the field is also time-consuming, and thus further contributes to down time.

The present application is directed to one or more of the above issues.

### SUMMARY

It has been recognized that it would be advantageous to develop a connection system for the flexible belt portion of a belted chain that is simpler, more flexible, and more robust than some prior belt connection systems.

It has also been recognized that it would be advantageous to have a connection system for the flexible belt portion of a belted chain that is simple to fix in the field.

In accordance with one embodiment thereof, the present application provides a belted chain connection system that includes first and second flexible belt portions, each flexible belt portion having first and second ends with integral lugs extending therefrom. A non-circular aperture extends transversely through the integral lugs, and a reinforcing ply is embedded within each flexible belt portion, the reinforcing ply having a continuous portion substantially circumscribing the non-circular aperture in each lug. A non-circular pin is configured to extend transversely through aligned non-circular apertures of the lugs of the first and second ends of adjacent belt segments, to non-rotatably connect the adjacent belt segments.

In accordance with another aspect thereof, the application provides a segment of a belted chain having a pair of parallel, flexible belt portions interconnected with transverse bars. Each flexible belt portion includes a belt body with first and second ends, having complementary-shaped integral lugs extending therefrom, and a non-circular aperture, extending transversely through each of the integral lugs. A reinforcing ply is embedded within the flexible belt, and continuously extends from the belt body into each lug, looping around the non-circular aperture therein, and extending back into the belt body. The non-circular apertures of interleaved lugs of the first and second ends of adjacent belt segments are configured to receive a congruently-shaped non-circular pin extending there through, to non-rotatably connect the adjacent belt segments.

In accordance with yet another aspect thereof, the application provides a segment of a belted chain having a pair of parallel, flexible belt portions interconnected with transverse bars. Each flexible belt portion includes a belt body having first and second ends, having integral lugs extending therefrom, and a non-circular aperture, extending transversely through the integral lugs. Each of the non-circular apertures of the first and second ends of adjacent belt segments are configured to receive a congruently-shaped non-circular pin extending therethrough. A reinforcing ply is embedded within the flexible belt, and continuously extends from the belt body into each lug, looping around the non-circular aperture therein, and extending back into the belt body. A pair of links are configured to non-rotatably connect the pair of non-circular pins together, thereby interconnecting the first and second flexible belt portions, to non-rotatably connect the adjacent belt segments.

### BRIEF DESCRIPTION OF THE DRAWINGS

Additional features and advantages of the disclosure will be apparent from the detailed description which follows, taken in conjunction with the accompanying drawings, which together illustrate, by way of example, features thereof, and wherein:

FIG. 1 is a perspective view of the nose end of a root crop harvester with multiple belted chains, in operation;

FIG. 2 is a more detailed perspective view of a portion of the nose end of the root crop harvester of FIG. 1, with the nose end exposed;

FIG. 3 is a top perspective view of a portion of a belted chain having a connection system configured in accordance with the present disclosure;

FIG. 4 is a close-up top perspective view of the belted chain connection system of FIG. 3;

FIG. 5 is a close-up bottom exploded view of the belted chain connection of FIG. 3;

FIG. 6 is a side view of the belt of FIG. 2 traversing a small diameter pulley;

FIG. 7 is a close-up top perspective view of another embodiment of a belted chain connection in accordance with the present disclosure;

FIG. 8 is a close-up perspective view of one end of the belted chain connection of FIG. 7;

FIG. 9 is a close-up top perspective view of another embodiment of a belted chain connection in accordance with the present disclosure;

FIG. 10 is a close-up bottom exploded view of the belted chain connection of FIG. 9;

FIG. 11 is a close-up bottom exploded view of an embodiment of belted chain connection in accordance with the present disclosure having a pin with a stepped cross-sectional shape;

FIG. 12 is a close-up bottom exploded view of an embodiment of belted chain connection in accordance with the present disclosure having a pin with a triangular cross-sectional shape;

FIG. 13 is a close-up bottom exploded view of an embodiment of belted chain connection in accordance with the present disclosure having a pin with an oval or elliptical cross-sectional shape;

FIG. 14 is a partially exploded perspective view of a belt connection having a cylindrical pin and tubular sleeves disposed in each aperture of each lug;

FIG. 15 is a partially exploded perspective view of a belt connection having a non-cylindrical pin and correspondingly shaped sleeves disposed in each aperture of each lug;

FIG. 16 is a bottom perspective view of a belted chain connection in accordance with the present disclosure having a flexible sheath wrapped around the connection region of the belts;

FIG. 17 is a top perspective view of the belt of FIG. 16 with the flexible sheath wrapped around the connection region;

FIG. 18 is a perspective view of a belt connection like that of FIG. 9, with lock nuts disposed at the ends of the pin;

FIG. 19 is a perspective view of a belt connection like that of FIG. 9, with a cotter pin disposed at each end of the pin; and

FIG. 20 is a top perspective view of a belt with a sleeved pin like that of FIGS. 14 and 15, having a pair of compression bands disposed around the interleaved lugs of the belt connection and a flexible sheath disposed around the belt connection and the compression bands.

### DETAILED DESCRIPTION

Reference will now be made to exemplary embodiments illustrated in the drawings, and specific language will be used herein to describe the same. It will nevertheless be understood that no limitation of the scope of the disclosed system is thereby intended. Alterations and further modifications of the inventive features illustrated herein, and additional applications of the principles thereof as illustrated herein, which would occur to one skilled in the relevant art and having possession of this disclosure, are to be considered within the scope of the disclosure.

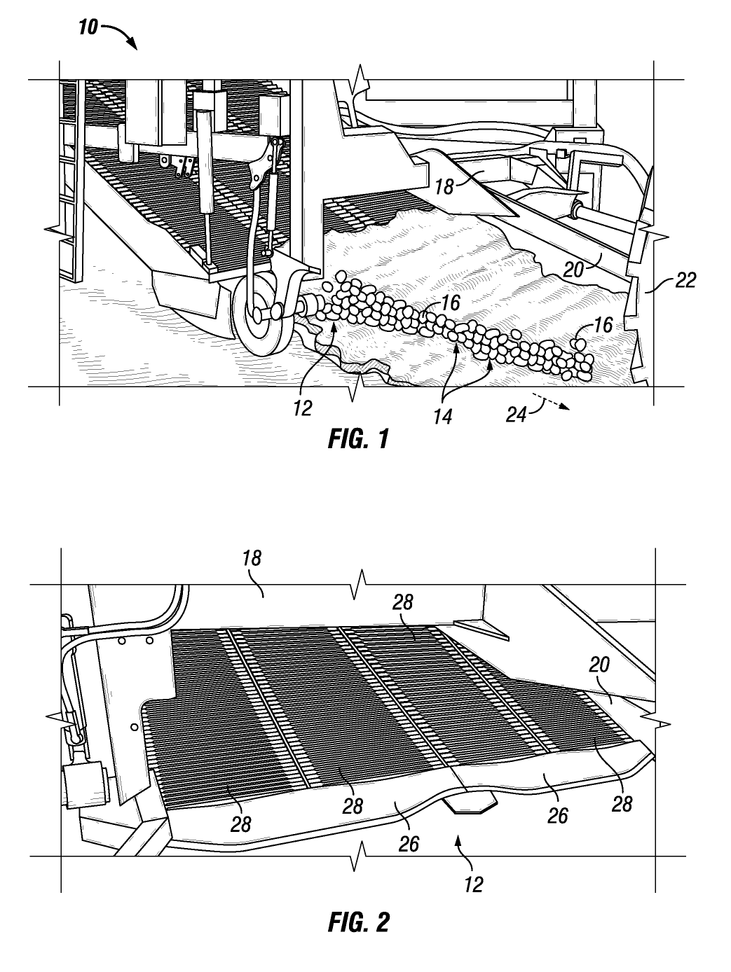

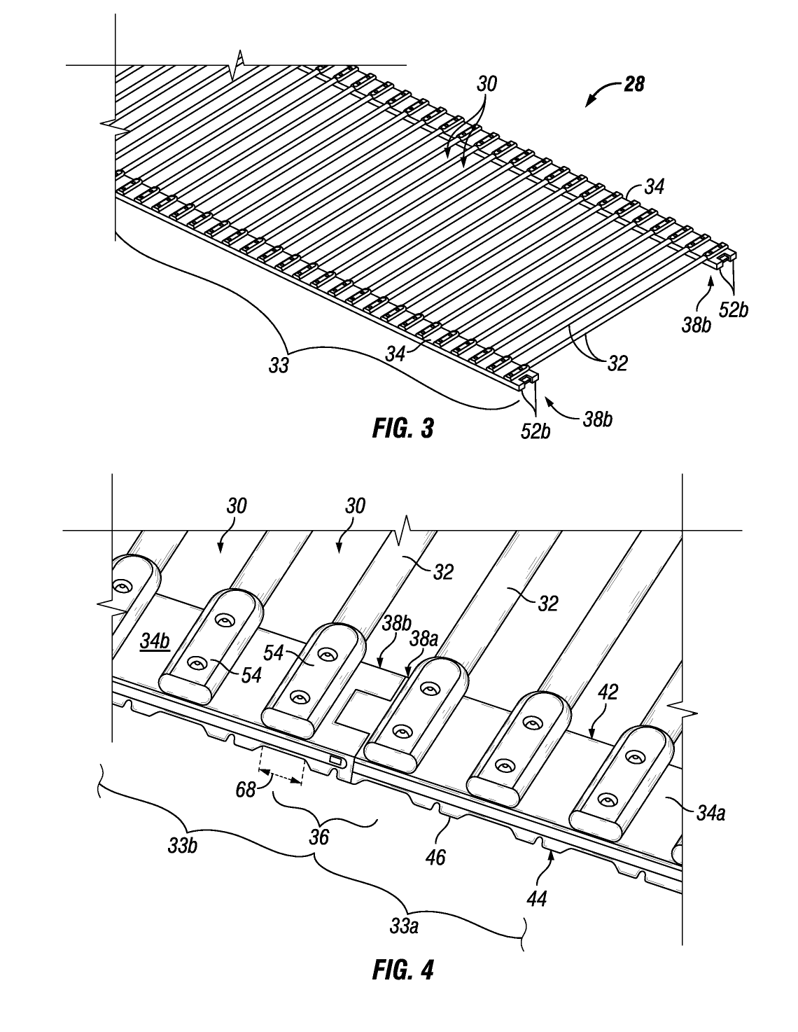

As noted above, the present application relates to belted chains, such as are used in agricultural equipment for harvesting root crops and the like. While the belted chains shown herein are depicted in the context of a harvester, it is to be understood that harvesters are only one type of agricultural machine that can employ belted chains of this type. Provided in FIG. 1 is a perspective view of the forward end 12 of a root crop harvester 10 in operation, and FIG. 2 provides a more detailed perspective view of the same, with the digging nose 26 exposed. In the process of harvesting root crops, a harvester 10 is typically drawn along rows 14 of crops 16, such as potatoes. The harvester 10, which can be as wide as three or four crop rows 14 (though harvesters that are as wide as 1 to 8 crop rows are well known), typically includes a wheeled main frame 18, and a hitch 20 for connecting the harvester 10 to a towing or pulling vehicle 22, such as a tractor, for pulling it in a field in a harvesting direction, indicated by arrow 24.

As shown most clearly in FIG. 2, the harvester 10 includes a digging nose 26 at its forward end 12. Behind the digging nose 26 are multiple belted chains 28. The digging nose 26 digs into the ground as the harvester 10 moves along in the harvesting direction 24, and the root crops 16 are lifted out of the ground and deposited onto the rearwardly adjacent section of belted chain 28. The belted chain 28 transports the root crops 16 up into the harvester 10 (e.g. to other belted chains or conveyors) so that they can be deposited into vehicles and transported out of the field.

Shown in FIG. 3 is a top perspective view of a portion of a segment 33 of a belted chain 28 like that used in the harvester 10 of FIGS. 1 and 2. Belted chains of this type generally include first and second narrow, parallel, flexible belt portions 34 (e.g. of rubber or the like) on opposing lateral sides, between which are connected a plurality of spaced apart transverse metal bars 32. The belted chain 28 facilitates the harvesting process by allowing dirt, roots, vines, etc. to drop through the gaps 30 between the bars 32 and away from the individual crops 16 (e.g. potatoes) as they are being transported, to initially clean the crops and reduce the amount of dirt and debris that is transported out of the field.

Belted chains of this type generally range from 12″ to 105″ wide (though other widths can also be used), and can be in any desired length. The transverse bars 32 are typically of steel, about 0.3 in. to 0.6 in. diameter, and are typically connected to the flexible belt portions 34 by rivets, bolts, or other mechanical fasteners. The size of the gaps 30 between adjacent bars 34 is dependent upon the pitch between adjacent bars 32, which typically ranges from 0.8 in. to 2.4 in., depending on the application.

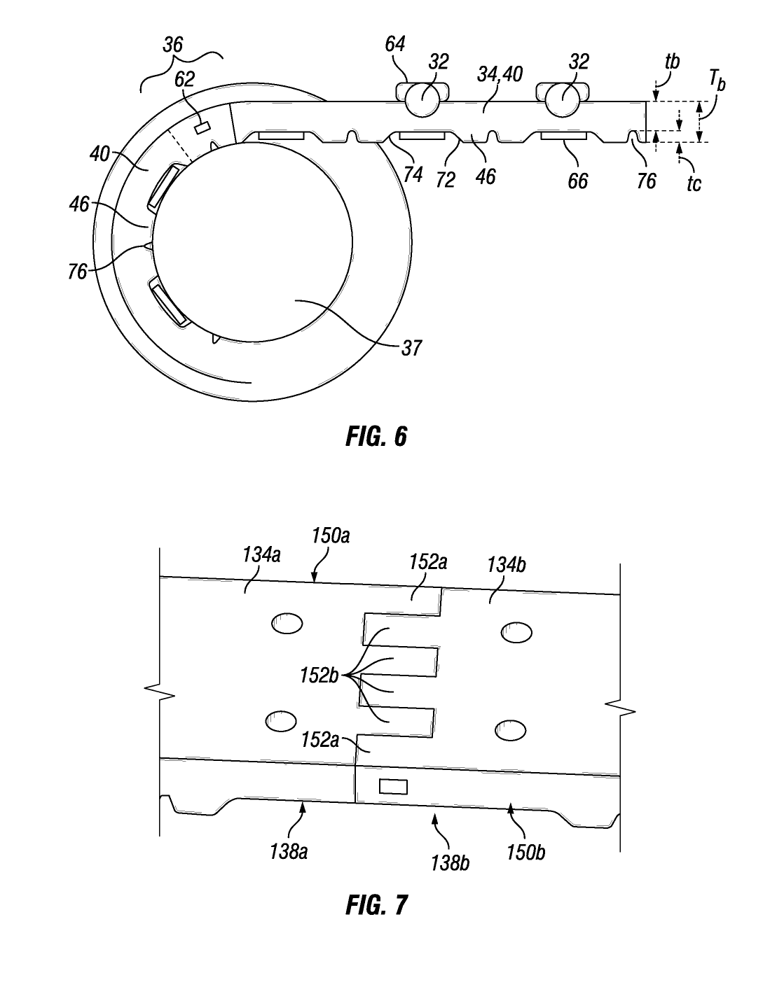

The flexible belt portions 34 of a single individual belted chain segment 33 is typically interconnected with itself end-to-end to form an endless belt of a desired length, which is routed around pulleys, drive wheels and rollers (e.g. roller 37 in FIG. 6) in the harvester 10 (or other machine) to allow the belt 28 to transport crops in the manner discussed above.

As noted above, one common challenge associated with belted chains of this sort is the manner in which the flexible rubber belt portions 34 of the belted chain segments 33 are connected together. In the past, these types of belted chains 28 have typically been interconnected with the use of metal clips that provide a hinge-type connection. Unfortunately, while this can provide a relatively strong connection between two belt segments 33, the metal clips are not flexible, and impose significant stress and wear on the flexible belt at their attachment locations with typical use, and typically introduce metal-on-metal sliding friction, and can wear away relatively quickly. These factors tend to increase maintenance expense and down time for harvesters and other similar machines that use them.

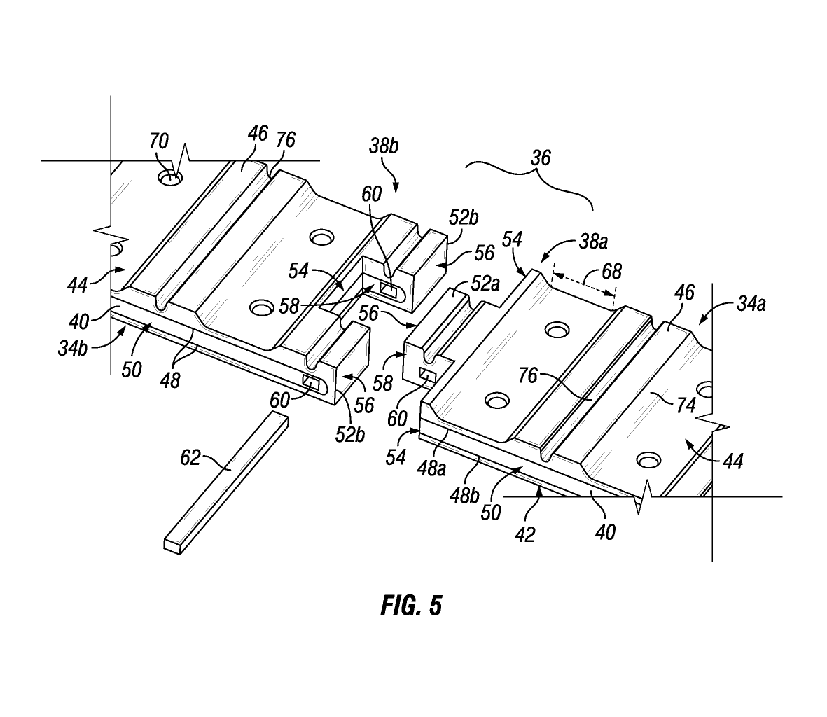

Advantageously, as disclosed herein, a connection system for the flexible belt portions 34 of a belted chain 28 has been developed that is simpler, more flexible, and more robust than some prior belt connection systems. Shown in FIGS. 4 and 5 are close-up views of the connection region 36 of the belt portions 34 of two segments 33a, 33b of a belted chain 28 in one embodiment of a connection system for flexible belts in accordance with the present disclosure. FIG. 4 provides a close-up top perspective view of the flexible belt portions 34 of the two belt segments 33a, b at the connection location 36, and FIG. 5 provides a close-up bottom exploded view of the connection location 36. In these views the first end 38a of a first belt portion 34a and the second end 38b of a second belt 34b are shown at the attachment location 36.

The flexible belt portions 34 include a belt body 40 of flexible material, such as rubber or the like, which can have a substantially flat top surface 42 and a bottom surface 44 with cleats 46 extending therefrom. Alternatively, the top surface 42 can have cleats or other features (not shown), rather than being flat. In general, the flexible belt portions 34 are likely to range from 40 mm to 75 mm wide and 0.5 in. to 1.0 in. thick, though other dimensions can be used. In one particular embodiment, the belt is about 60 mm wide, with the body 40 of the belt having a thickness t_{b} of 9 mm, and the cleats 46 having a thickness t_{c} of 3.5 mm, for a total belt thickness T_{b} of 12.5 mm. One or more reinforcing plies 48, typically of woven fabric, metal, or other flexible reinforcing material, can be embedded within the body 40 of the belt for greater strength. The flexible belt portions 34 can be fabricated using materials and techniques that are well known in the tire and rubber industry, such as by molding. The edges 50 of the belt can be rubber coated or otherwise sealed to prevent moisture and chemicals from contacting and potentially rotting or otherwise damaging the reinforcing plies 48.

At the longitudinal ends 38, each flexible belt portion 34 has one or more integral lugs 52 extending from the belt body 40. In the embodiment shown in FIGS. 4 and 5 the first end 38a includes one central lug 52a and the second end 38b has two lugs 52b positioned at the lateral sides of the flexible belt portion. These lugs 52 are an integral extension of the material of the belt body 40, and can be formed in the end of the belt body 40 by molding or cutting, for example. The lugs 52 of the first and second ends 38a, b have complementary-shapes, and are configured to interleave with each other. More particularly, the first end 38a of the first belt 34a includes a single, central lug 52a, with a pair of shoulders 54a at either side thereof, and the second end 38b of the second belt 34b includes a pair of lugs 52b that extend to the lateral edges 50 of the belt, with a recessed shoulder 54 between them. The dimensions of these lugs 52 can vary. In one exemplary embodiment, the lugs 52 are about 13 mm long, the single central lug 52a at the first end 38a of the first belt portion 34a is about 24 mm wide and the pair of lugs 52b at the lateral edges 50 of the second end 38b of the second belt portion 34b are about 18 mm wide.

The integral lugs 52 of the respective belt ends 38 include mating surfaces that contact each other. Specifically, all of the lugs 52 include end surfaces 56 that are configured to butt against the adjacent shoulder surfaces 54 of a connected belt segment, and also include side surfaces 58 that are configured to contact the side surfaces 58 of the adjacent lugs 52 of the connected belt segment. This contact helps resist relative rotation of the belts when the first and second ends 38a, b are connected.

A non-circular aperture 60 extends transversely through each of the integral lugs 52 at a position that allows the respective non-circular apertures 60 of the first and second ends 38a, b to align with each other when the lugs 52 are interleaved. When these apertures 60 are aligned, a non-circular pin 62 can be extended through the aligned apertures 60 of the interleaved lugs 52 to non-rotatably connect the belt portions 34 together. The non-circular pin 62 has a cross-sectional shape that is congruent—i.e. substantially the same size and shape—with the apertures 60 of the lugs 52 of the first and second ends 38a, b of the adjacent belt portions 34. In this context, the term substantially the same size is intended to mean that the cross-sectional dimensions of the pin 62 and the aperture 60 are within about 10% of each other. The size of the pin 62 and of the apertures 60 can vary. In one embodiment like that shown in FIGS. 4 and 5 the rectangular aperture 60 and the pin 62 have a height or thickness of about 3 mm and a width of about 5 mm.

The non-circular pin 62 can be of any suitably strong material, such as metal, though non-metals can also be used if they have sufficient strength. Steel pins are considered to be most likely. Non-corrosive metals such as stainless steel, aluminum, galvanized steel, bronze, etc. are also suitable, and can be desirable for the operating environment for this type of belt. Because the belt portions 34 are of flexible, resilient rubber or rubber-like material, and the pin 62 is of metal or other more rigid material, the aperture 60 can be sized to provide a tight friction fit between the pin 62 and the material of the belt. Advantageously, the pin 62 can be engineered to shear before the belt body 40 tears. That is, the pin 62 can be of a size, shape and material that is just slightly weaker than the weakest portion of the belt body 40, so that when high forces (e.g. tensile force) are applied to the belt 34 the pin 62 will fail before the belt as a whole fails. In a failure or over-stress situation, this helps to preserve a given belt segment (e.g. segment 33 in FIG. 3), which is relatively costly, at the expense of the much cheaper pins 62, which can be more easily replaced to repair the belted chain.

The reinforcing ply 48 that is embedded within the body 40 of each flexible belt portion 34 can be configured in various ways. In general, the reinforcing ply 48 includes at least one continuous portion that substantially circumscribes the non-circular aperture 60 in each lug 52. In this context, the term “substantially circumscribes” means that the reinforcing ply 48 extends from within the body 40 of the belt and loops around the top, bottom and distal ends of the aperture 60 within each lug. In the embodiment of FIGS. 4 and 5, the reinforcing ply 48 includes a top layer 48a and bottom layer 48b of reinforcing fabric, the two layers being portions of a single fabric ply or piece 48, which is doubled back over itself and substantially circumscribes the non-circular aperture 60 in each lug 52. The reinforcing ply 48 extends from the belt body 40 into each lug, loops around the non-circular aperture 60 in the respective lug, and extends back into the belt body 40.

The flexible belt 34 can include various additional features, as shown in FIGS. 4 and 5. As noted above, the bottom surface 44 can include tapered cleats 46 extending from the bottom surface 44 of the belt body 40. These cleats 46 facilitate driving of the belt around rollers and pulleys, and also reduce potential damage from contact with these and other features. As can be seen in FIGS. 3 and 4, the transverse bars 32 of the belted chain 28 each include an end plate 64 that contacts the top surface 42 of the belt. Disposed against the bottom side of the belt, opposite the end plate 64 of each transverse bar, is a backer plate 66 disposed in each space 68 that lies between adjacent cleats 46. The body 40 of the belt includes one or more vertical apertures 70, through which a rivet or other fastener is extended to securely connect the end plate 64 of a given transverse bar 32 to the backer plate 66 on the opposite side of the belt body 40. The body 40 of the belt is thus clamped between the end plate 64 of each bar 32 and the corresponding backer plate 66, for a secure connection of the transverse bars 32 to the flexible belt portions 34. Because of the thickness of the backer plates 66, and any fasteners that may protrude from their bottom surface, the cleats 46 have a thickness t_{c} that is at least equal to the thickness of the backer plate 66 and any protruding fastener ends. This prevents the backer plates 66 from contacting pulleys, drive wheels, etc. (e.g. roller 37 in FIG. 6) as the belted chain 28 is in use, thus reducing wear to the belt portions 34 and to the machine to which the belt is attached.

The shape of the non-circular pin 62 and of the corresponding apertures 60 creates a non-pivoting connection between the joined belt portions 34, and does so without large rigid connecting clips and the like, or metal hinges, as are used in the prior art. This gives the belt portion 34 greater overall flexibility when pivoting around pulleys, wheels, etc., while still keeping the belt ends from moving significantly with respect to one another, thus preserving the desired shape of the belt and reducing wear. Provided in FIG. 6 is a side view of a belted chain 28 like that of FIGS. 4 and 5 traversing a small diameter pulley 37, which illustrates these features. As can be seen, the belt portions 34 adjacent to the non-circular pin 62 are fully able to flex as the belt traverses the wheel 37, yet experience relatively little friction between materials of different hardness (e.g. between the metal pin 62 and the rubber belt portion 34), thus reducing wear.

Additionally, as shown in FIGS. 5 and 6, the design of the cleats 46 also helps reduce pinching by the metal parts of the belted chain 28. The cleats 46 of the belt can be molded or cut into the belt body 40 with features that provide clearance for the metal parts as the belt goes around rollers, etc. Specifically, the cleats 46 include rounded edges 72 and tapered side surfaces 74 having an angle α (e.g. 40°) that helps prevent the cleats 46 from pinching the backer plates 66 when the flexible belt portion bends tightly around a pulley or roller 37. That is, the angled surface 74 and relieved edges 72 of the cleats 46 prevent the side surfaces of the cleat 46 from pinching inward against the backer plates 66 when the belt wraps around a roller 37. The cleats 46 can also include a central relief slot 76 (e.g. about ⅛″ to 3/16″ wide and as deep as the full thickness of the cleat 46) that allows easier transition of the flexible belt portion 34 around rollers and pulleys 37 without bubbling or bulging, to help provide a high degree of flexibility.

Another feature that is visible in FIGS. 4 and 5 is the position of the belt connection 36 relative to the cleat 46 location(s). Specifically, the belt connection region 36 is positioned to coincide with a location of a cleat 46. Since the backer plates 66 for the transverse bars 32 are positioned in the space 68 between adjacent cleats 46, this places the belt connection region 36 between adjacent transverse bars 32, so that the spacing of the transverse bars 32 can be consistent, and so that there is no need to connect a transverse bar 32 at or through a belt connection location 36. This can assist the function of the belted chain 28 and also simplify maintenance of it.

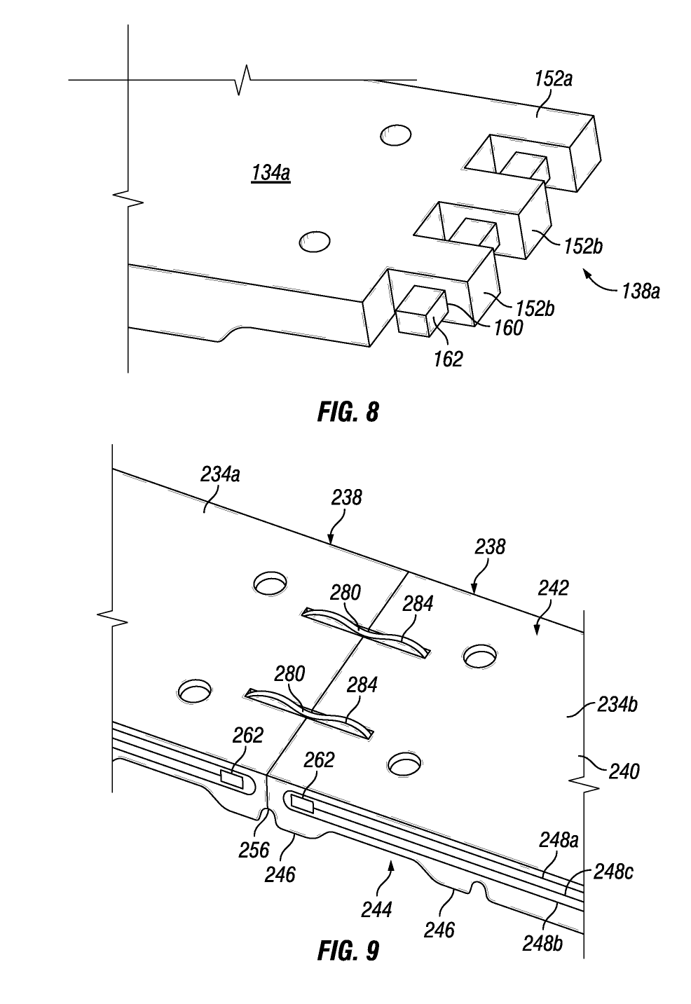

The flexible belt connection embodiment of FIGS. 4 and 5 has a symmetrical connecting lug arrangement, with only one lug 52a on a first belt 34a that connects between two symmetrically positioned lugs 52b of a second belt 34b. However, the number and arrangement of lugs 52 can take other configurations. For example, as shown in FIGS. 7 and 8, a flexible belt 134 of the type disclosed herein can include a connection system with multiple lugs 152 on each end, and these can have a symmetrical or asymmetrical arrangement. The embodiment shown in FIGS. 7 and 8 is generally like that described above, except for the number and position of the lugs. Specifically, each flexible belt portion 134 has three integral lugs 152 extending from the longitudinal ends 138 of the belt body 140, each end 138 including one lug 152a that is positioned along a side or edge 150 of the belt, and the others spaced from it in one direction toward the opposite edge 150.

Like the embodiment of FIGS. 4 and 5 discussed above, the lugs 152 of the first and second ends 138a, b have complementary shapes, and are configured to interleave with each other, with end and side mating surfaces that contact each other. A non-circular aperture 160 extends transversely through all of the integral lugs 152 and these apertures 160 align with each other when the lugs 152 are interleaved, allowing a non-circular pin 162 to be extended through the apertures 160 to non-rotatably connect the belt portions 134 together.

It will be apparent, however, that the centroid of the lugs 152 of the corresponding ends 138 of the belts in FIGS. 7 and 8 do not exactly line up. That is, the group of three lugs 152 of one belt end 138 are positioned toward one lateral edge 150 of the belt, while the group of three lugs 152 on the other belt end 138 are positioned toward the opposite lateral edge 150 of the belt. This configuration may be less desirable in some situations, depending on the forces (e.g. tensile forces) that are expected to be imposed upon the belt. Nevertheless, the number and position of the integral lugs 152 for the belted chain connection system disclosed herein can vary in this and in other ways.

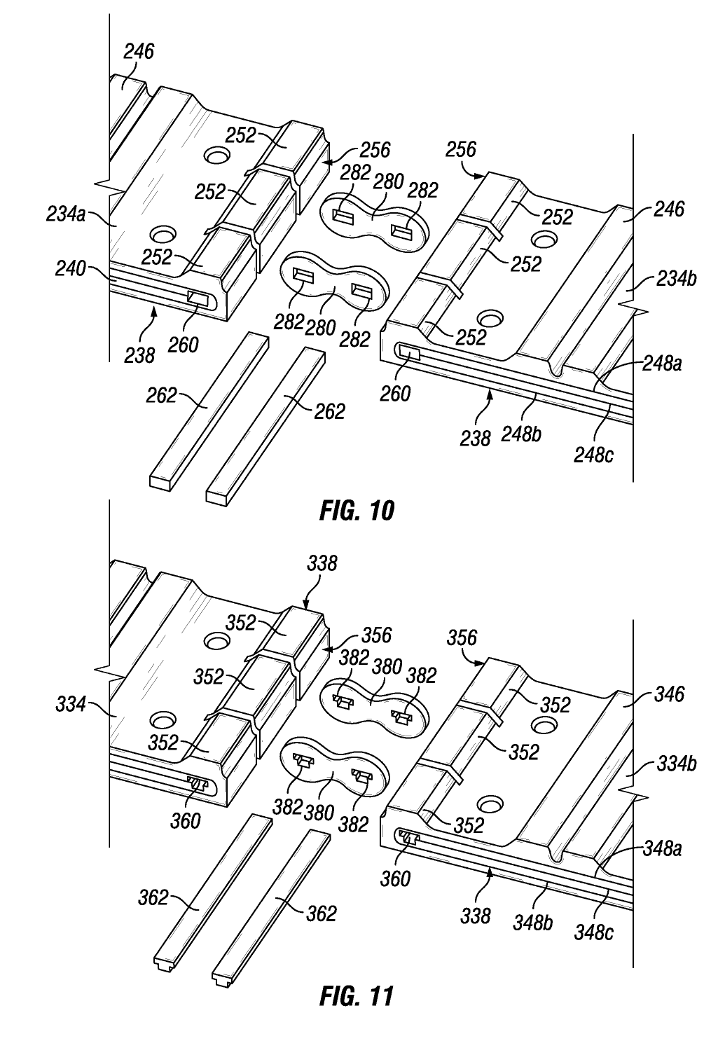

Another embodiment of a belted chain connection system, in accordance with the present disclosure is shown in FIGS. 9 and 10. A top view of the connected belt portions 234 in this embodiment is shown in FIG. 9, and a bottom view of the unconnected belt portions 234 is shown in FIG. 10. Like the belted chain connection shown in FIGS. 4 and 5, this embodiment includes first and second flexible belt portions 234, with a generally flat top surface 242 and a bottom surface 244 with cleats 246 extending therefrom. Each flexible belt portion 234 has first and second ends 238 with integral lugs 252 extending therefrom. In the embodiment shown in FIGS. 9 and 10, each belt end 238 includes at least three lugs 252, in a symmetrical configuration, having an aligned non-circular aperture 260, extending transversely through the integral lugs 252. The flexible belt portions 234 can include one or more plies 248 of reinforcing material, as discussed above, embedded within the body 240 of the belt portion, the reinforcing plies 248 including at least one continuous portion that substantially circumscribes the non-circular aperture 260 in each lug.

In this embodiment, the non-circular apertures 260 of the lugs 252 are configured to receive a non-circular pin 262, which extends transversely through the aligned apertures 260, and non-rotatably connects the adjacent belt segments. Rather than one transverse pin 262, however, a pair of non-circular pins 262 are included, each pin 262 configured to extend transversely through the non-circular apertures 260 of one and only one of the first and second ends of the first and second flexible belt portions. The lugs 252 are relatively wide and closely spaced. In one embodiment of this configuration, the lugs 252 are from 17 mm-22 mm wide and the space between adjacent lugs 252 is about 2 mm wide and about 13 mm deep.

At least two links 280 are provided, which fit into narrow slots 253 between the adjacent lugs 252 of each of the belt ends 234. The links 280 include non-circular apertures 282 that correspond to the cross-sectional shape of the non-circular pins 262, and are configured to align with the non-circular apertures 260 of each belt end. The links 280 thus non-rotatably connect the pair of pins 262 together when the non-circular pins 262 are extend through the apertures 260, thereby interconnecting the first and second flexible belt portions 234. The links 280 can be of steel or other strong material, and can be engineered to shear before the belt body 240 tears. That is, the links 280 can be of a size, shape and material that is just slightly weaker than the weakest portion of the belt body 240, so that when high forces are applied to the belt 234 the links 280 will fail before the belt as a whole fails. Alternatively, the pins 262 can be engineered to shear first in an over-stress situation, as discussed above with respect to the embodiment of FIGS. 4 and 5. In a failure or over-stress situation, this helps to preserve a given belt segment (e.g. segment 33 in FIG. 3), which is relatively costly, at the expense of the much cheaper links 280 or pins 262, which can be more easily replaced to repair the belted chain (28 in FIG. 3). Suitable materials for the links 280 include materials that are suitable for the pins 262, such as steel, stainless steel, etc. It is to be understood that the number of lugs 252 and thus the number of spaces between adjacent lugs 252 and the number of links 280 can vary from that shown.

The lugs 252 include end surfaces 256 that contact each other and resist relative rotation of the belt ends 238 at the connection location 236 when the belts are connected via the non-circular pins 262 and links 280. Viewing FIGS. 9 and 10 it can be seen that the belt connection is provided at a location of a cleat 246, so that the spacing between the transverse bars (32 in FIG. 4) is not affected by the position of the connection. As shown in FIG. 9, the links 280 can extend slightly above the top surface 242 of the belt 234. This does not affect the function of the belt 234 or the quality of the connection. The top edges 284 of the links 280 can be rounded as shown to reduce stress that they may impose upon contact with pulleys, rollers or other items, including crop units (e.g. potatoes 16 in FIG. 1).

The embodiment of FIGS. 9 and 10 also illustrates an alternative configuration of the reinforcing plies 248 in the belt. Like the embodiment of FIGS. 4 and 5, the flexible belt 234 includes reinforcing plies 248 that are embedded within the belt body 240, and include at least one continuous portion that extends from the belt body 240, substantially circumscribes the non-circular aperture 260 in each lug 252, and extends back into the belt body 240. In the embodiment of FIGS. 9 and 10, however, the reinforcing plies 248 includes three layers of reinforcing fabric. The top and bottom layers of reinforcing fabric, indicated at 248a, b, are part of a single fabric ply or piece 248, which is doubled back over itself and substantially circumscribes the non-circular aperture 260 in each lug 252, as discussed. On the other hand, the third reinforcing ply 248c is positioned between the top and bottom layers 248a, b, and ends at the non-circular aperture 260, without extending around it.

The non-circular connecting pins for the various belt connection embodiments shown and described herein can vary in their cross-sectional shape. These shapes can be polygonal, semi-polygonal or curved, so long as they are not circular. Referring to FIGS. 4 and 5, a circular pin could allow the connected belt portions 34 to pivot significantly at the connection location 36. A few of the many possible shapes for the transverse pins and transverse apertures are illustrated herein. In the embodiments of FIGS. 4-5 and 9-10 each non-circular pin 62, 262 has a rectangular cross-sectional shape, and is configured to extend through a correspondingly-shaped aperture 60, 260. In this and other embodiments disclosed herein the pin 62, 262 and the aperture 60, 260 can have rounded corners, so as to reduce stress concentrations that can affect the durability of the flexible belt portion 34, 234.

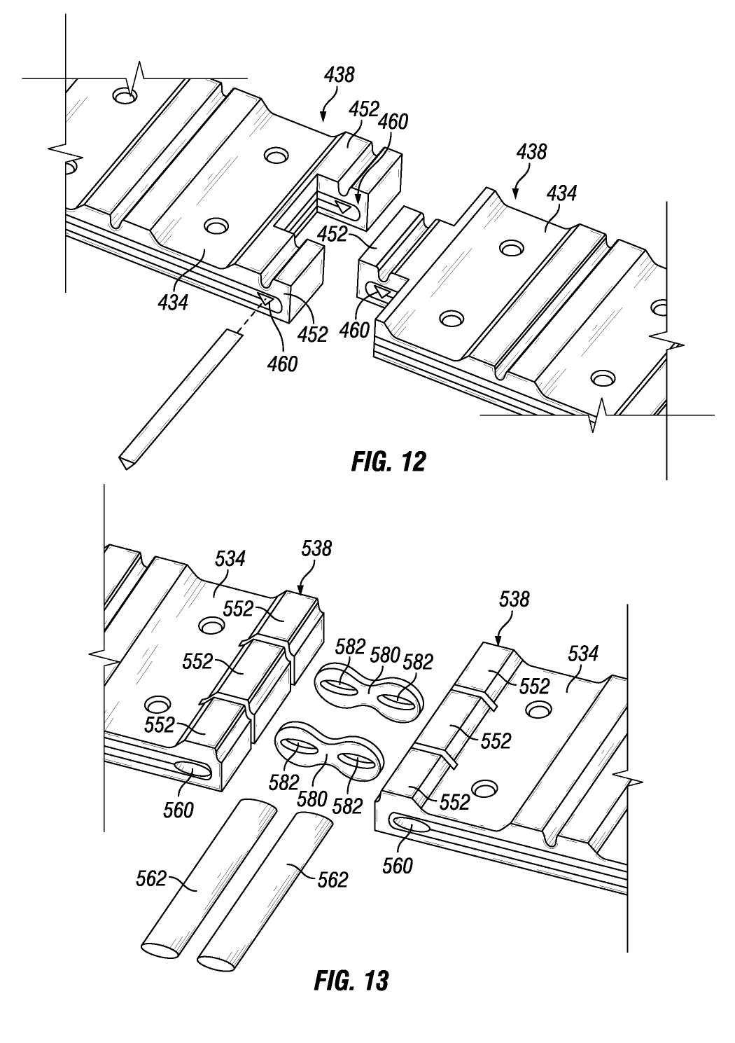

Another pin configuration is shown in FIG. 11, which provides a close-up bottom exploded view of an embodiment of the ends 338 of the flexible belt portions 334 of a belted chain connection like that of FIGS. 9 and 10. In this embodiment, the pins 364 have a stepped cross-sectional shape, with correspondingly shaped apertures 360 in the lugs 352 and apertures 382 in the links 380. As another alternative, shown in FIG. 12 the ends 438 of the flexible belt portions 434 of a belted chain connection like that of FIGS. 4 and 5 is shown with a pin 462 having a triangular cross-sectional shape, and correspondingly shaped apertures 460 that are provided in the lugs 452 of the flexible belt. In yet another embodiment, shown in FIG. 13 the ends 538 of the flexible belt portions 534 of a belted chain connection like that of FIGS. 9 and 10 can employ pins 562 with an oval or elliptical cross-sectional shape, with correspondingly shaped apertures 560 in the lugs 552 and in the links 580. In each of these embodiments, the shape of the pins and of the apertures and links (where applicable) resist relative rotation of the connected belt ends in the manner discussed herein, providing a secure connection while simultaneously reducing wear and increasing flexibility of the belt connection region in comparison to prior belt connection systems. It is to be appreciated that other shapes and sizes of pins and apertures can also be used.

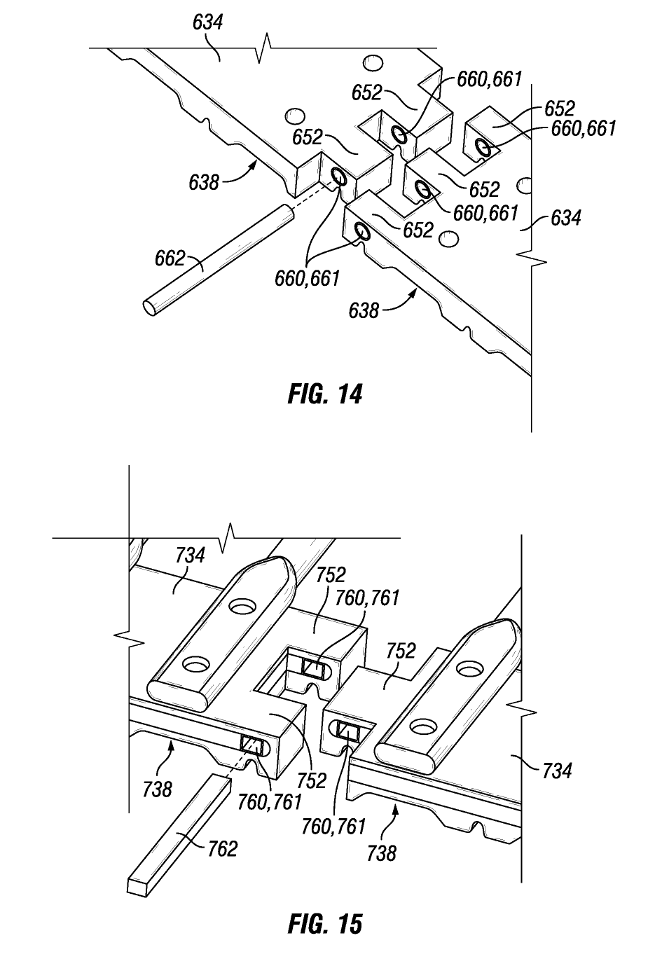

While the pins shown in FIGS. 5-13 are non-circular, circular pins can also be used. Shown in FIG. 14 is a partially exploded perspective view of a belt connection having a cylindrical pin 662. In this embodiment, the pin 662 is cylindrical, and is configured to fit within tubular sleeves 661, provided in the apertures 660 of the lugs 652 of the ends 638 of the belt portions 634. The tubular sleeves 661 can be placed in each aperture 660 of each lug 652 either during a molding process or via a press fit. The tubular sleeves 661 and the cylindrical pin 662 can be of steel, stainless steel, bronze or other metals. The tubular sleeves 661 are fixed with respect to the lugs 652, while the pin 662 can slidingly rotate within the sleeves. This helps reduce friction between the pin and the surrounding rubber belt material, thus reducing wear and increasing the life of the belt. While the circular or cylindrical pin 662 can rotate within its tubular sleeve 661, the geometry of the lugs 652 will still tend to prevent relative rotation and flexure of the belt connection in this embodiment. Thus, while this embodiment will allow a slightly higher degree of flexure at the belt connection location than the embodiments shown herein that have a non-circular pin, flexure and pivoting is still largely resisted by the design of the connection, thus increasing the life of the connection.

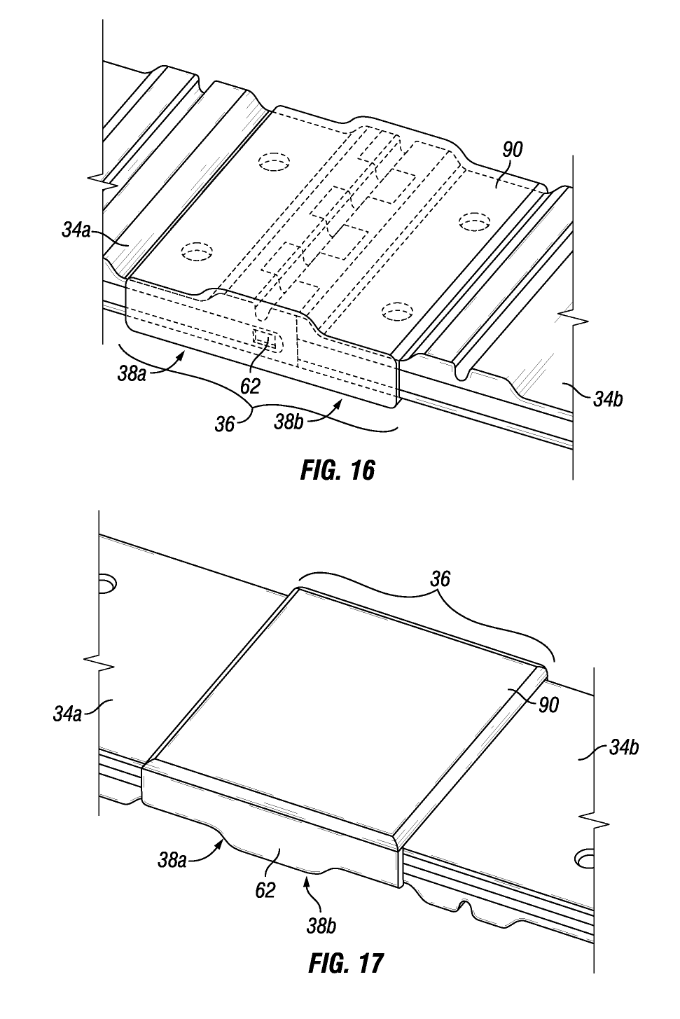

A configuration like that shown in FIG. 14 can also be configured with a non-circular pin. Shown in FIG. 15 is a partially exploded perspective view of a belt connection having a non-cylindrical pin 762, and correspondingly shaped sleeves 761 provided in the apertures 760 of the lugs 752 of the ends 738 of the belt portions 734. As with the embodiment of FIG. 14, the sleeves 761 can be placed in each aperture 760 of each lug 752 either during a molding process or via a press fit. The tubular sleeves 761 and the cylindrical pin 762 can be of steel, stainless steel, bronze or other metals. The tubular sleeves 761 are fixed with respect to the lugs 752, and the shape of the pin 762 resists rotation of the pin within the sleeves 761.

The belt connection system shown and described herein can also include additional features. As shown in FIGS. 16 and 17, a belt connection system like that shown in FIGS. 4 and 5 can include a flexible protective sheath 90 that wraps around the connection region 36 of the connected first and second ends 38a, b of the flexible belt 34. In these views the details of the covered connection location 36 are shown in dashed lines. The flexible sheath 90 can be a polymer material, which can have elastic properties that allow it to snugly wrap around the connection location 36. Alternatively, the flexible sheath 90 can be a heat-shrink material that is wrapped around the connection location 36 and then shrunk by the application of heat to provide a flexible seal. This flexible sheath is desirable to prevent dirt, debris and water from contacting the connection location 36, and for resisting corrosion of the pin 62 and links of the connection.

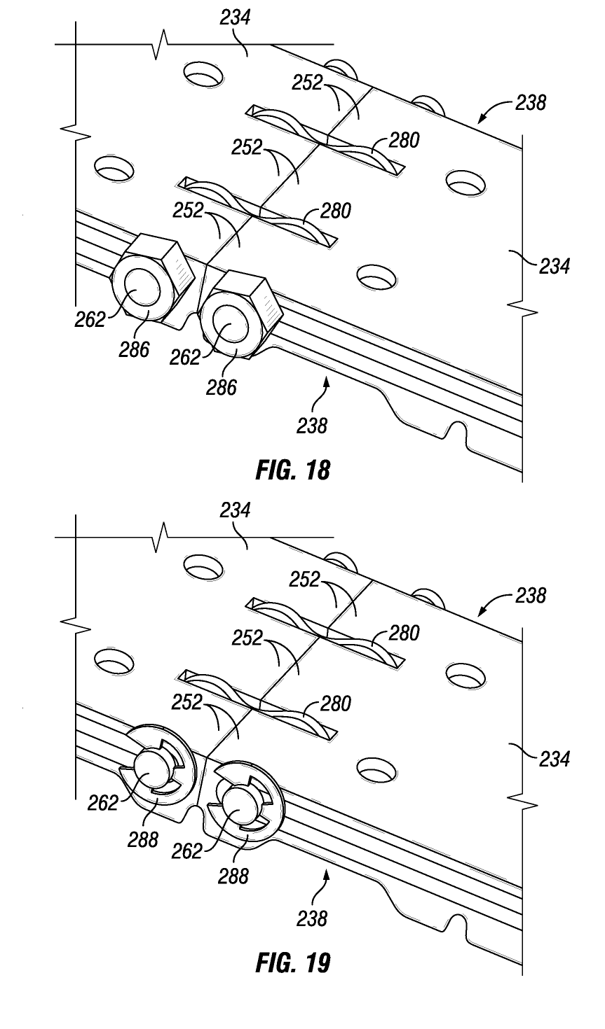

Additional features that help retain the connecting pin in place can also be provided. Shown in FIG. 18 is a perspective view of a belt connection like that of FIG. 9, having structure for retaining the connecting pin. In this configuration the flexible belt portions 234 have integral lugs 252 that are connected by a pair of transverse pins 262 and links 280, as described above. To help retain the pins 262 in place and also retain the shape and integrity of the belt connection, the ends of the pins include lock nuts 286. Lock nuts or other pin retaining structure can be provided with circular or non-circular pins. For example, where non-circular pins are used, only an extreme end portion of the pin can be cylindrical and threaded, thus allowing the lock nut to be threaded on, while the remainder of the pin is non-circular.

Other structure for retaining the pins can also be used. Shown in FIG. 19 is a perspective view of another embodiment of a belt connection like that of FIG. 9, in which the transverse pins 262 include retainer rings 288. The retainer rings 288 help retain the pins 262 in place and also retain the shape and integrity of the belt connection. As with the lock nuts 286 shown in FIG. 18, the retainer rings 288 can be provided with circular or non-circular pins 262.

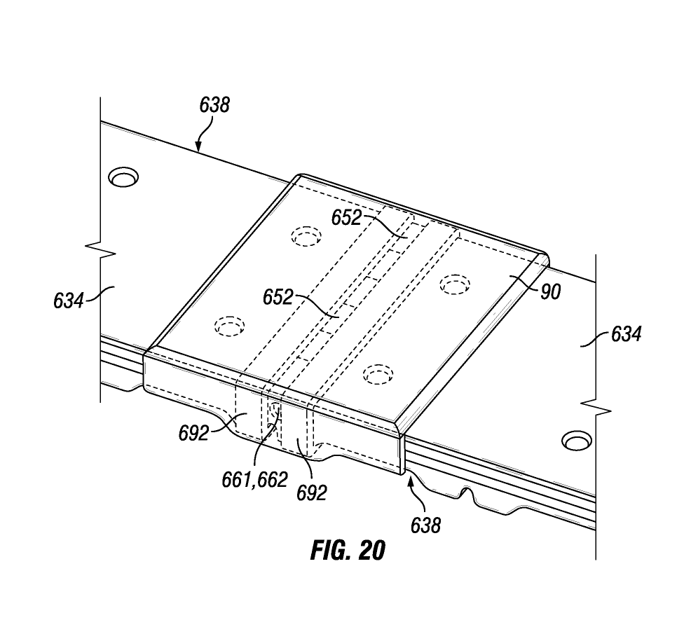

Another feature that can be included in a belt connection as disclosed herein is the use of compression bands at the belt connection location. Shown in FIG. 20 is a top perspective view of a belt connection like that of FIGS. 14 and 15. This belt connection includes a cylindrical pin 664 that is disposed within tubular sleeves 661 that extend through the lugs 652. A pair of compression bands 692 are disposed around the interleaved lugs 652 of the belt connection on opposing sides of the location of the pin 664. These compression bands 692 can be of metal (e.g. stainless steel) or other suitably strong material, and help to prevent strain and distortion of the lugs 652 due to tensile stress on the belt 634, and thus increase the strength and life of the belt connection. A flexible tubular sheath 690 is also disposed around the belt connection to encase and protect the belt connection (including the compression bands 692) in the manner discussed above with respect to FIGS. 16 and 17.

The disclosure thus provides a belted chain or a segment of a belted chain, having a pair of parallel, flexible belt portions interconnected with transverse bars. Each flexible belt portion includes a belt body having first and second ends, with integral lugs extending therefrom, and a non-circular aperture, extending transversely through the integral lugs. Each of the non-circular apertures of the first and second ends of adjacent belt segments are configured to receive a congruently-shaped non-circular pin extending therethrough.

The belted chain connection system as disclosed helps to reduce or eliminate failure due to metal-on-metal wear that prior belts exhibit. Advantageously, with non-circular pins and holes, the connection joint doesn't pivot, which extends its life. This connection system also helps to reduce or eliminate failure due to metal-on-rubber wear. For example, having the joint built into the belt takes the place of metal clips being attached to the belt, as in the prior art, and also makes the joint relatively narrow and small, allowing it to travel around rollers and wheels more easily. This configuration also helps reduce failure due to fabric separating from rubber in the belt. Specifically, the sealed belt edges help prevent water and chemicals from getting into the fabric, which tend to promote failure of the belt. The design of the cleats also helps reduce pinching of the belt by other metal parts of the belted chain. The cleats of the belt can be molded into the belt with rounded edges and slots to give room for the metal parts as the belt goes around rollers, etc.

The belt connection disclosed herein also facilitates the creation of a single continuous belt from multiple belt segments, if desired. As noted above, belted chains that are currently known are typically created by connecting opposite ends of a single belt segment into a continuous loop. This requires a belt segment of a specific length for a given application. Conversely, the belt connection disclosed herein allows belts to be produced in individual segments of various lengths, so that multiple belt segments can be connected together for a desired length of continuous belt. This may not be a common approach, but is facilitated by this connection design. It will be appreciated that adding more connections to a belt can increase the number of locations that are prone to wear. However, it is believed that the connection configuration shown herein reduces the wear at each joint to such an extent that even a belt with multiple connections of this sort can have greater reliability than a prior art belt with just a single connection location.

It is to be understood that the above-referenced arrangements are illustrative of the application of the principles of the present disclosure. It will be apparent to those of ordinary skill in the art that numerous modifications can be made without departing from the principles and concepts of the disclosure as set forth in the claims.

What is claimed is:

1. A belted chain connection system, comprising:
first and second flexible belt portions, each flexible belt portion having first and second ends with integral lugs extending therefrom;
a non-circular aperture, extending transversely through the integral lugs;
a reinforcing ply, embedded within each flexible belt portion, the reinforcing ply having a continuous portion substantially circumscribing the non-circular aperture in each lug; and
a non-circular pin, configured to extend transversely through aligned non-circular apertures of the lugs of the first and second ends of adjacent belt segments, to non-rotatably connect the adjacent belt segments.

2. A system in accordance with claim 1, wherein the first end includes one central lug and the second end includes two lugs positioned toward lateral sides of the flexible belt portion.

3. A system in accordance with claim 2, further comprising multiple lugs at each of the first and second ends.

4. A system in accordance with claim 2, wherein the lugs of the first and second ends of adjacent belt segments are configured to interleave with the respective non-circular apertures aligned, the non-circular pin being configured to extend through the apertures of the interleaved lugs.

5. A system in accordance with claim 4, wherein the integral lugs of the respective belt ends include mating surfaces that contact each other and resist relative rotation when the first and second ends are connected.

6. A system in accordance with claim 1, further comprising a hollow sleeve, disposed within the non-circular aperture of each lug, configured to receive the non-circular pin in a sliding fit.

7. A system in accordance with claim 1, wherein the flexible belt portions comprise vulcanized rubber material, having a substantially flat top surface and a bottom surface with tapered cleats extending therefrom, the reinforcing ply comprising two layers of reinforcing fabric, the two layers comprising a single fabric ply doubled back over itself and substantially circumscribing the non-circular aperture in each lug.

8. A system in accordance with claim 1, further comprising a flexible sheath, configured to wrap around a region of the connected first and second ends.

9. A system in accordance with claim 1, wherein the non-circular pin comprises a pair of non-circular pins, each configured to extend transversely through the non-circular apertures of one of the first and second ends of the first and second flexible belt portions, and further comprising a pair of links, configured to non-rotatably connect the pair of non-circular pins together, thereby interconnecting the first and second flexible belt portions.

10. A system in accordance with claim 9, wherein the first and second ends include end surfaces that contact each other and resist relative rotation when the pair of non-circular pins are connected by the links.

11. A segment of a belted chain, having a pair of parallel, flexible belt portions interconnected with transverse bars, each flexible belt portion comprising:
a belt body with first and second ends, having complementary-shaped integral lugs extending therefrom;
a non-circular aperture, extending transversely through the integral lugs;
a reinforcing ply, embedded within the flexible belt, continuously extending from the belt body into each lug, looping around the non-circular aperture therein, and extending back into the belt body; and
wherein the non-circular apertures of interleaved lugs of the first and second ends of adjacent belt segments are configured to receive a congruently-shaped non-circular pin extending therethrough, to non-rotatably connect the adjacent belt segments.

12. A segment of a belted chain in accordance with claim 11, wherein the first end includes one central lug and the second end includes two lugs positioned toward lateral sides of the flexible belt portion.

13. A segment of a belted chain in accordance with claim 11, further comprising multiple lugs at each of the first and second ends.

14. A segment of a belted chain in accordance with claim 11, wherein the integral lugs of the respective belt ends include mating surfaces that contact each other and resist relative rotation when the first and second ends are connected.

15. A segment of a belted chain in accordance with claim 11, further comprising a flexible sheath, configured to wrap around a region of the connected first and second ends.

16. A segment of a belted chain in accordance with claim 11, wherein the flexible belt portions comprise vulcanized rubber material, having a substantially flat top surface and a bottom surface with tapered cleats extending therefrom.

17. A segment of a belted chain, having a pair of parallel, flexible belt portions interconnected with transverse bars, each flexible belt portion comprising:
a belt body having first and second ends, having integral lugs extending therefrom, and a non-circular aperture, extending transversely through the integral lugs, each of the non-circular apertures of the first and second ends of adjacent belt segments being configured to receive a congruently-shaped non-circular pin extending therethrough;
a reinforcing ply, embedded within the flexible belt, continuously extending from the belt body into each lug, looping around the non-circular aperture therein, and extending back into the belt body; and
a pair of links, configured to non-rotatably connect the pair of non-circular pins together, thereby interconnecting the first and second flexible belt portions, to non-rotatably connect the adjacent belt segments.

18. A segment of a belted chain in accordance with claim 17, wherein the first and second ends include end surfaces that contact each other and resist relative rotation when the pair of non-circular pins are connected by the links.

19. A segment of a belted chain in accordance with claim 17, further comprising a flexible sheath, configured to wrap around a region of the connected first and second ends.

20. A segment of a belted chain in accordance with claim 17, wherein the flexible belt portions comprise vulcanized rubber material, having a substantially flat top surface and a bottom surface with tapered cleats extending therefrom.
